(19) United States
(12) Patent Application Publication
(10) Pub. No.: US 2026/0289130 A1
(43) Pub. Date: Sep. 24, 2026

(54) CONTEXT-AWARE FEATURE-BASED DYNAMIC SYSTEM FOR ENTITY PREDICTION, VALIDATION, CORRECTION, AND AUGMENTATION IN TABULAR DATASETS

(71) Applicant: HITACHI VANTARA LLC, Santa Clara, CA (US)

(72) Inventors: Divya SINGH, Tokyo (JP); Satoru WATANABE, Tokyo (JP); Kunju KASHALIKAR, Hudson, MA (US)

(21) Appl. No.: 19/088,517

(22) Filed: Mar. 24, 2025

(51) Int. Cl. G06F 40/295; G06F 40/242

(52) U.S. Cl. CPC G06F 40/295; G06F 40/242

(57) ABSTRACT

A method for performing entity detection that comprises receiving, by a processor, data to be classified; generating, by the processor, an entity prediction and a feature vector from the data using a trained Artificial Intelligence (AI) model; computing, by the processor, a confidence score for the entity prediction from the feature vector; comparing, by the processor, the confidence score against a confidence threshold; and for the confidence score being equal to or less than the confidence threshold, performing, by the processor, entry update on a dynamic dictionary, wherein the dynamic dictionary comprises a plurality of entity entries with extracted feature vectors.

### BACKGROUND

### Field

The present disclosure is generally directed to methods and systems for performing entity detection/recognition.

### Related Art

The global data catalog market has seen tremendous growth with increase in data volumes. A data catalog is a centralized repository that helps organizations discover, organize, and manage their data assets efficiently. Regulations protecting personal data have increased with growing demand for protection of sensitive information. To comply with these regulations, the first challenge is to detect the Personal Identifiable Information (PII) from the data. Before classifying the entity to PII, entity recognition would first need to be performed.

Traditional entity recognition methods rely heavily on experts to create predefined patterns and rules, which have limited ability to understand relationships between data fields and less adaptable to new PII patterns. The methods require significant manual effort to update and maintain the classification rules, leading to inefficiencies. Further, context information is not being considered in performing entity recognition.

In the related art, a method for performing entity recognition through use of multiple embedding engines is disclosed. Each embedding engine processes data independently without understanding the relationships between the columns, and there is no mechanism to capture the table-to-table or column-to-column relationships of the data. Furthermore, utilization of multiple embedding engines further increases computational overhead and system complexity.

### SUMMARY

Example implementations perform entity prediction, validation, correction, and augmentation in tabular datasets using a context-aware feature-based dynamic system. Unlike traditional entity recognition methods that rely on predefined rules or multiple embedding engines, example implementations dynamically learn from data, allowing accurate identification of entities even when column names are unknown.

Aspects of the present disclosure involve an innovative method for performing entity detection. The method may include receiving, by a processor, data to be classified; generating, by the processor, an entity prediction and a feature vector from the data using a trained Artificial Intelligence (AI) model; computing, by the processor, a confidence score for the entity prediction from the feature vector; comparing, by the processor, the confidence score against a confidence threshold; and for the confidence score being equal to or less than the confidence threshold, performing, by the processor, entry update on a dynamic dictionary, wherein the dynamic dictionary comprises a plurality of entity entries with extracted feature vectors.

In some example implementations, the trained AI model is generated by receiving synthetic data for performing entity recognition; and performing training of an AI model using the synthetic data to generate the trained AI model, wherein the trained AI model performs entity recognition and prediction on input data.

In some example implementations, the dynamic dictionary is generated by: receiving the plurality of entity entries as output from the trained AI model with the synthetic data as input; performing feature vector extraction for the plurality of entity entries to generate the extracted feature vectors; and storing the plurality of entity entries and the extracted feature vectors as entries in the dynamic dictionary for validation.

In some example implementations, the processor is configured to compute the confidence score for the entity prediction by comparing the feature vector against the extracted feature vectors to compute similarity scores between the feature vector and the extracted feature vectors; and converting the similarity scores into the confidence score.

In some example implementations, the processor is configured to perform the entry update on the dynamic dictionary by: identifying a subset of the extracted feature vectors with closest semantic similarity to the feature vector from the extracted feature vectors; computing one or more correlation coefficients between the feature vector and the subset of the extracted feature vectors; converting the one or more correlation coefficients into one or more probability values; and comparing the one or more probability values against a second confidence threshold.

In some example implementations, the processor is configured to perform the entry update on the dynamic dictionary by further performing: for all of the one or more probability values being less than or equal to the second confidence threshold, generating a new entry for the data in the dynamic dictionary, wherein the new entry comprises an entity label and a newly generated feature vector of the data derived using a pre-trained transformer model.

In some example implementations, the pre-trained transformer model comprises a Bidirectional Encoder Representations from Transformers (BERT) model.

In some example implementations, the method may further include, for at least one probability value of the one or more probability values being determined to exceed the second confidence threshold: determining entity correction is required for entity entry associated with the entity prediction as contained in the dynamic dictionary; generating a weighted averaged feature vector by performing weighted averaging of (i) the feature vector; and (ii) at least one feature vector associated with the at least one probability value; and correcting the entity entry associated with the entity prediction by replacing the feature vector with the weighted averaged feature vector in the dynamic dictionary.

In some example implementations, the method may further include, for the confidence score being greater than the confidence threshold, outputting, by the processor, the entity prediction and the feature vector for review.

In some example implementations, the method may further include displaying, by the processor, the entity prediction, the feature vector, and the confidence score using a graphical user interface.

Aspects of the present disclosure involve an innovative system for performing entity detection. The system may include a data storage; and a processor in communication with the data storage, wherein the processor is configured to: receive data to be classified; generate an entity prediction and a feature vector from the data using a trained Artificial Intelligence (AI) model; compute a confidence score for the entity prediction from the feature vector; compare the confidence score against a confidence threshold; and for the confidence score being equal to or less than the confidence threshold, perform entry update on a dynamic dictionary stored in the data storage, wherein the dynamic dictionary comprises a plurality of entity entries with extracted feature vectors.

In some example implementations, the trained AI model is generated by: receiving synthetic data for performing entity recognition; and performing training of an AI model using the synthetic data to generate the trained AI model, wherein the trained AI model performs entity recognition and prediction on input data.

In some example implementations, the dynamic dictionary is generated by: receiving the plurality of entity entries as output from the trained AI model with the synthetic data as input; performing feature vector extraction for the plurality of entity entries to generate the extracted feature vectors; and storing the plurality of entity entries and the extracted feature vectors as entries in the dynamic dictionary for validation.

In some example implementations, the processor is configured to compute the confidence score for the entity prediction by: comparing the feature vector against the extracted feature vectors to compute similarity scores between the feature vector and the extracted feature vectors; and converting the similarity scores into the confidence score.

In some example implementations, the processor is configured to perform the entry update on the dynamic dictionary by: identifying a subset of the extracted feature vectors with closest semantic similarity to the feature vector from the extracted feature vectors; computing one or more correlation coefficients between the feature vector and the subset of the extracted feature vectors; converting the one or more correlation coefficients into one or more probability values; and comparing the one or more probability values against a second confidence threshold.

In some example implementations, the processor is configured to perform the entry update on the dynamic dictionary by further performing: for all of the one or more probability values being less than or equal to the second confidence threshold: generate a new entry for the data in the dynamic dictionary, wherein the new entry comprises an entity label and a newly generated feature vector of the data derived using a pre-trained transformer model.

In some example implementations, the pre-trained transformer model comprises a Bidirectional Encoder Representations from Transformers (BERT) model.

In some example implementations, the processor is further configured to: for at least one probability value of the one or more probability values being determined to exceed the second confidence threshold: determine entity correction is required for entity entry associated with the entity prediction as contained in the dynamic dictionary; generate a weighted averaged feature vector by performing weighted averaging of (i) the feature vector; and (ii) at least one feature vector associated with the at least one probability value; and correct the entity entry associated with the entity prediction by replacing the feature vector with the weighted averaged feature vector in the dynamic dictionary.

In some example implementations, the processor is further configured to, for the confidence score being greater than the confidence threshold, output the entity prediction and the feature vector for review.

In some example implementations, the processor is further configured to display the entity prediction, the feature vector, and the confidence score using a graphical user interface.

Aspects of the present disclosure involve an innovative non-transitory computer readable medium, storing instructions for performing entity detection. The instructions may include receiving data to be classified; generating an entity prediction and a feature vector from the data using a trained Artificial Intelligence (AI) model; computing a confidence score for the entity prediction from the feature vector; comparing the confidence score against a confidence threshold; and for the confidence score being equal to or less than the confidence threshold, performing entry update on a dynamic dictionary, wherein the dynamic dictionary comprises a plurality of entity entries with extracted feature vectors.

In some example implementations, the trained AI model is generated by receiving synthetic data for performing entity recognition; and performing training of an AI model using the synthetic data to generate the trained AI model, wherein the trained AI model performs entity recognition and prediction on input data.

In some example implementations, the dynamic dictionary is generated by: receiving the plurality of entity entries as output from the trained AI model with the synthetic data as input; performing feature vector extraction for the plurality of entity entries to generate the extracted feature vectors; and storing the plurality of entity entries and the extracted feature vectors as entries in the dynamic dictionary for validation.

In some example implementations, computing the confidence score for the entity prediction comprises comparing the feature vector against the extracted feature vectors to compute similarity scores between the feature vector and the extracted feature vectors; and converting the similarity scores into the confidence score.

In some example implementations, performing the entry update on the dynamic dictionary comprises: identifying a subset of the extracted feature vectors with closest semantic similarity to the feature vector from the extracted feature vectors; computing one or more correlation coefficients between the feature vector and the subset of the extracted feature vectors; converting the one or more correlation coefficients into one or more probability values; and comparing the one or more probability values against a second confidence threshold.

In some example implementations, performing the entry update on the dynamic dictionary further comprises: for all of the one or more probability values being less than or equal to the second confidence threshold, generating a new entry for the data in the dynamic dictionary, wherein the new entry comprises an entity label and a newly generated feature vector of the data derived using a pre-trained transformer model.

In some example implementations, the pre-trained transformer model comprises a Bidirectional Encoder Representations from Transformers (BERT) model.

In some example implementations, the method may further include, for at least one probability value of the one or more probability values being determined to exceed the second confidence threshold: determining entity correction is required for entity entry associated with the entity prediction as contained in the dynamic dictionary; generating a weighted averaged feature vector by performing weighted averaging of (i) the feature vector; and (ii) at least one feature vector associated with the at least one probability value; and correcting the entity entry associated with the entity prediction by replacing the feature vector with the weighted averaged feature vector in the dynamic dictionary.

In some example implementations, the instructions may further include, for the confidence score being greater than the confidence threshold, outputting the entity prediction and the feature vector for review.

In some example implementations, the instructions may further include displaying the entity prediction, the feature vector, and the confidence score using a graphical user interface.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example process flow 100 for performing entity recognition model and dynamic dictionary generation, in accordance with an example implementation.

FIG. 2 illustrates an example process flow 200 for performing context-aware entity recognition/prediction using a dynamic dictionary, in accordance with an example implementation.

FIG. 3 illustrates an example process flow 300 for performing entry update on the dynamic dictionary, in accordance with an example implementation.

FIG. 4 illustrates an example system diagram 400 of an entity recognition system, in accordance with an example implementation.

FIG. 5 illustrates an example process flow 500 for creating/generating the dynamic dictionary, in accordance with an example implementation.

FIG. 6 illustrates an example process flow 600 for performing entity prediction and validation, in accordance with an example implementation.

FIG. 7 illustrates an example process flow 700 for performing entity correction, in accordance with an example implementation.

FIG. 8 illustrates an example process flow 800 for performing new entity detection and augmentation, in accordance with an example implementation.

FIG. 9 illustrates an example process flow 900 for performing model adaptation and fine-tuning, in accordance with an example implementation.

FIG. 10 illustrates an example Graphical User Interface (GUI) 1000, in accordance with an example implementation.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations provide a dynamic, context-aware system for accurately predicting, validating, correcting, and augmenting entity names in tabular datasets with unknown column labels. Row-wise feature vector generation, semantic similarity, and confidence scoring are leveraged to ensure accurate column-level predictions while dynamically updating a dictionary to handle new or previously unseen entities. Example implementations further minimize computational overhead and adapt to evolving datasets in real-time.

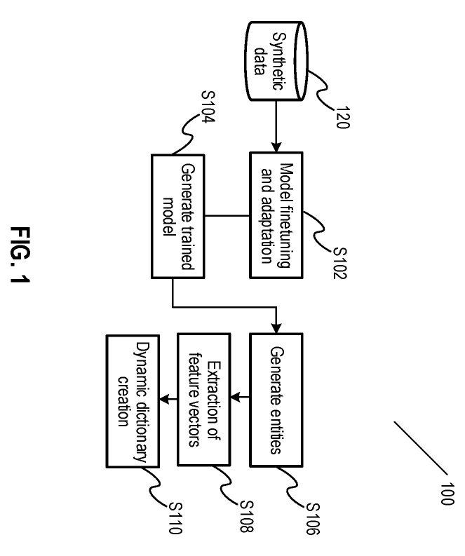

FIG. 1 illustrates an example process flow 100 for performing entity recognition model and dynamic dictionary generation, in accordance with an example implementation. The process flow 100 begins by performing model finetuning and adaption at step S102, where a model is generated and fine-tuned using synthetic data 120 to enhance entity recognition capabilities. In some example implementations, the model may be one or more Artificial Intelligence (AI)/Machine Learning (ML) models.

The AI/ML model may include, but not limited to, one or more of convolutional neural network (CNN), recurrent neural network (RNN), deep RNN (DRNN), Q-learning network (QN), deep Q-learning network (DQN), decision trees, K-Nearest Neighbors, etc. RNN may include long short-term memory (LSTM), large language model (LLM), etc.

At step S104, a trained model then generated and saved and later use. At step S106 entity prediction is performed to generate entities (entity entries) from the synthetic data 120 using the trained model. The process then continues to step S108 where feature vector extraction is performed to extract feature vectors that correspond to the entity entries using the trained model. At step S110, a dynamic dictionary is created by compiling the entity entries and associated extracted feature vectors. The dynamic dictionary is periodically saved/updated to ensure availability for future entity classification tasks. Utilization of the dynamic dictionary eliminates the need for frequent model retraining by continuously updating feature representations.

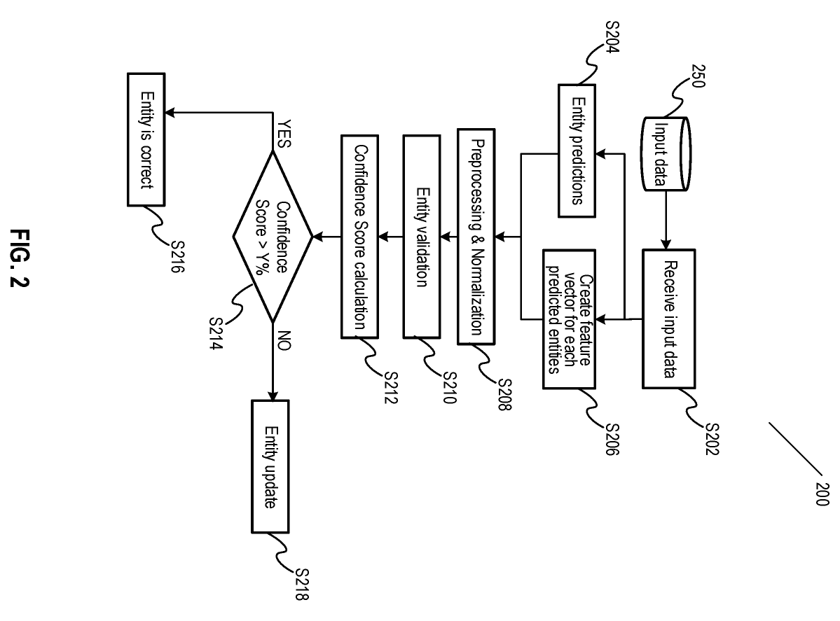

FIG. 2 illustrates an example process flow 200 for performing context-aware entity recognition/prediction using a dynamic dictionary, in accordance with an example implementation. The trained model and the dynamic dictionary are deployed to the customer side to perform real-time entity recognition/prediction. The process flow 200 begins at step S202 where data to be classified (input data 250) is received by the trained model. The trained model then generates entity prediction(s) (e.g., predicted entity names) and feature vector for each of the predicted entities at steps S204 and S206. The feature vectors serve as numerical representations of each data column.

Each of the feature vectors undergo preprocessing and normalization at step S208 before being validated using the dynamic dictionary at step S210. A confidence score is then computed to assess the reliability of the predicted entity name based on similarity to dictionary entries at step S212.

Following confidence computation, a determination is then made to see whether the confidence score exceeds a confidence threshold (e.g., Y%) at step S214. The confidence threshold may be adjusted based on manual input (e.g., by an operator) or adjusted according to a predetermined accuracy level/value. If the confidence score is greater than the confidence threshold, the process then continues to step S216 where entity prediction is confirmed as correct, and processing proceeds to the next entity column. If the confidence score is less than or equal to the confidence threshold, then an entry update is performed on the dynamic dictionary at step S218, which will be described in more detail below.

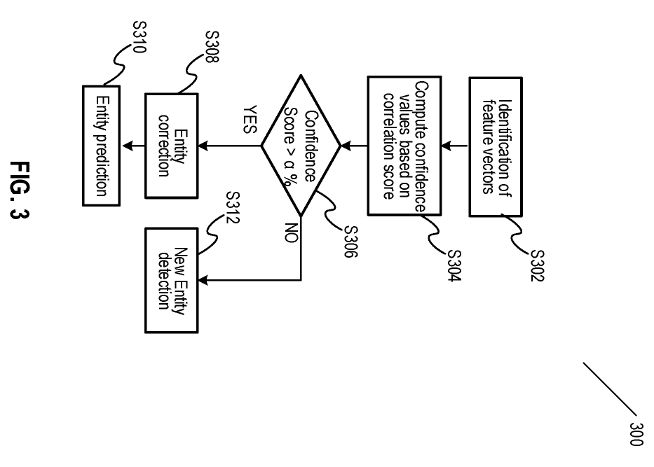

FIG. 3 illustrates an example process flow 300 for performing entry update on the dynamic dictionary, in accordance with an example implementation. The process 300 begins at step S302 where the system identifies extracted feature vectors from the dynamic dictionary that are closest in correlation to the feature vector of the input data. At step S304, new confidence scores are computed based on correlation values between the feature vector and the identified extracted feature vectors.

At step S306, a determination is then made to see whether one or more of the new confidence scores exceed a second confidence threshold α. If one or more of the new confidence scores exceed the second confidence threshold α, then the process continues to step S308 where entity correction is performed and the dynamic dictionary is updated. At step S310, a final entity prediction process is performed using the corrected feature representation.

If none of the new confidence scores exceeds the second confidence threshold, the process then continues to step S312 where a new entity is entered for the data in the dynamic dictionary to ensure adaptability for future classifications, which will be described in more detail below.

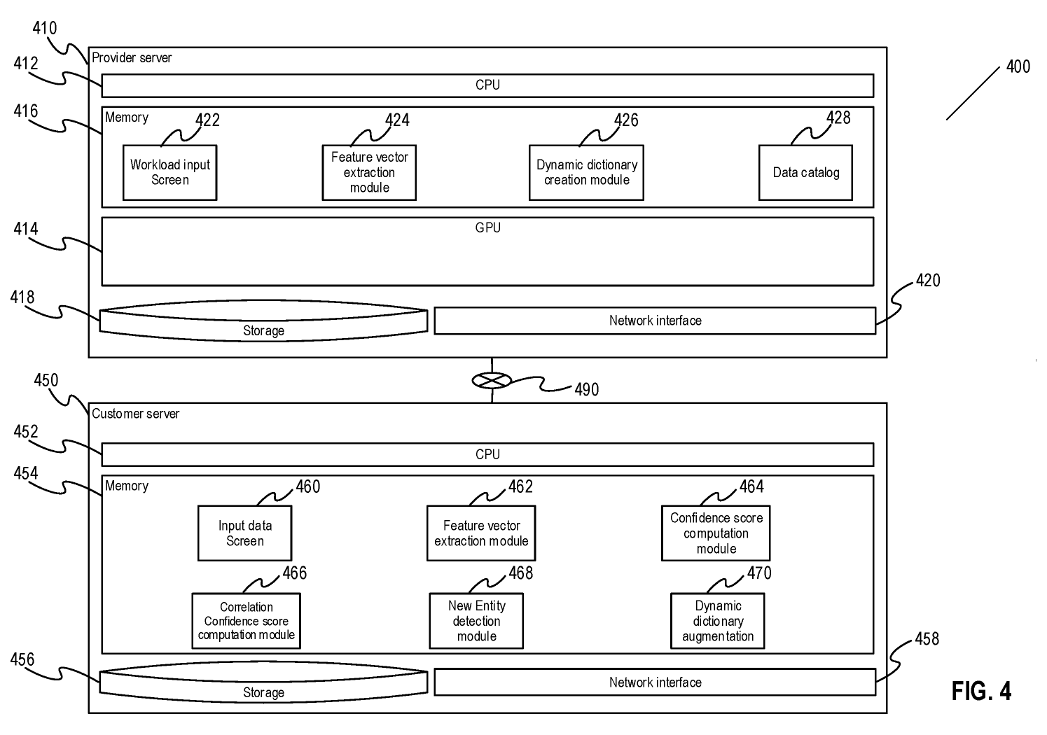

FIG. 4 illustrates an example system diagram 400 of an entity recognition system, in accordance with an example implementation. As shown in FIG. 4, the system diagram 400 comprises two primary components: a provider server 410 and a customer server 450. The provider server 410 may include components such as, but not limited to, a Central Processing Unit (CPU) 412, a Graphics Processing Unit (GPU) 414, a memory 416, a storage 418, and a network interface 420. The CPU 412 and GPU 414 may be used to handle processing and computations associated with AI/ML model generation/training and dynamic dictionary generation/updating.

The memory 416 may be used to store key functional modules/instructions for performing model and dynamic dictionary generation. The memory 416 may include subcomponents such as, but not limited to, a workload input screen 422, a feature vector extraction module 424, a dynamic dictionary creation module 426, a data catalog 428, etc. The workload input screen 422 allows for data ingestion, which undergoes feature extraction through the feature vector extraction module 424 for feature vector extraction before being processed for dynamic dictionary creation at the dynamic dictionary creation module 426. In some example implementations, the trained model and the dynamic dictionary may be stored at the memory 416 and/or the storage 418.

The data catalog 428 is integrated for managing metadata, which ensures that structured entity classification is being performed. Synthetic data used in the training of the model may be stored in the storage 418. Data, models, and/or dynamic dictionaries as stored in the provider server 410 may be transmitted to the customer server 450 via a network 490 using the network interface 420.

The customer server 450 may include components such as, but not limited to, a Central Processing Unit (CPU) 452, a memory 454, a storage 456, and a network interface 458. The trained model and/or the dynamic dictionary may be stored in either the memory 454 or the storage 456. The CPU 452 may be used to handle processing and computations associated with entity recognition/classification, dynamic dictionary updating, etc. The memory 454 may store essential modules required for entity recognition and classification. The memory 454 may include subcomponents such as, but not limited to, an input data screen 460, a feature vector extraction module 462, a confidence score computation module 464, a correlation confidence score computation module 466, a new entity detection module 468, a dynamic dictionary augmentation module 470, etc.

The input data screen 462 may receive data to be classified/recognized by the trained model. The feature vector extraction module 462 may be used to derive feature vectors from the received data. In some example implementations, the trained model may perform both entity predictions and feature vector extractions on the received data.

The confidence score computation module 464 may then generate a confidence score for the predicted entity, which is used to validate the prediction. The correlation confidence score computation module 466 may be used to refine classification should the confidence score not satisfy a predetermined threshold (e.g., confidence threshold). In some example implementations, if further validation is needed, user intentions may be considered before entity correction is initiated.

Upon correction, the dynamic dictionary is updated and entity prediction is refined. If it is determined that a new dictionary entry (e.g., new entity) is to be entered, the new entity detection module 468 is triggered to perform entity and feature vector generation on the input data. The dynamic dictionary augmentation module 470 is then used to incorporate the newly generated entity-feature vector entry to the dynamic dictionary. The network interface 458 facilitate data exchange with the provider server 410 for seamless updating and processing via the network 490.

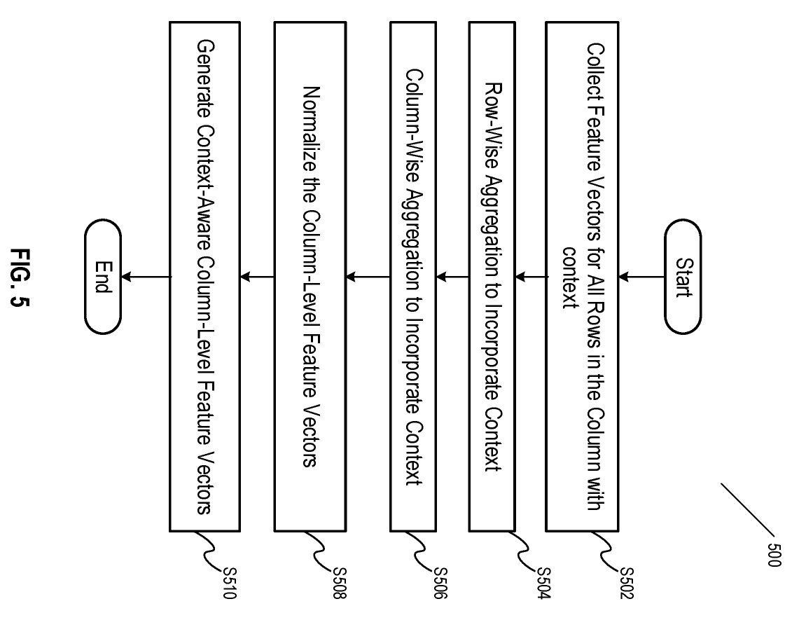

FIG. 5 illustrates an example process flow 500 for creating/generating the dynamic dictionary, in accordance with an example implementation. By leveraging row-wise and column-wise feature vector aggregation, the system enables accurate and adaptive entity recognition on tabular datasets with unknown column names. The process begins at step S502 where feature vectors for all rows in the column with context are collected. The row-wise feature vectors are extracted using a fine-tuned transformer model such as a Bidirectional Encoder Representations from Transformers (BERT) model.

These vectors incorporate not only the entity’s intrinsic properties but also contextual information from other columns in the dataset. Once feature vectors are collected, row-wise aggregation is performed to incorporate context aggregates feature vectors across all rows of a column at step S504. This ensures that entity representations capture dependencies within the dataset, allowing the system to recognize the patterns.

Following row-wise aggregation, the process continues to step S506 where column-wise aggregation is performed refines the row-aggregated feature vectors by considering column-level dependencies. This ensures that entity feature representations account for both localized row-wise context and broader column-wide trends, enhancing prediction of entities.

To ensure numerical stability, normalization of the column-level feature vectors is performed at step S508. This scales the aggregated vectors consistently and facilitates more accurate similarity-based matching when entities undergo validation, correction, or augmentation.

At step S510, final refined feature vectors/final context-aware column-level feature vectors are generated. These vectors serve as the core entity representations, and enable the validation, correction, and augmentation processes as shown in FIGS. 2-3.

The process then continues to step S512 where the final feature vectors are added to the dynamic dictionary. In some example implementations, the system may also record metadata attributes (e.g., confidence scores, timestamps, correlation metrics), to allow continuous learning and refinement over time. The dictionary enables efficient entity validation and correction, reduces dependency on static classification rules, and improves adaptability to changing datasets.

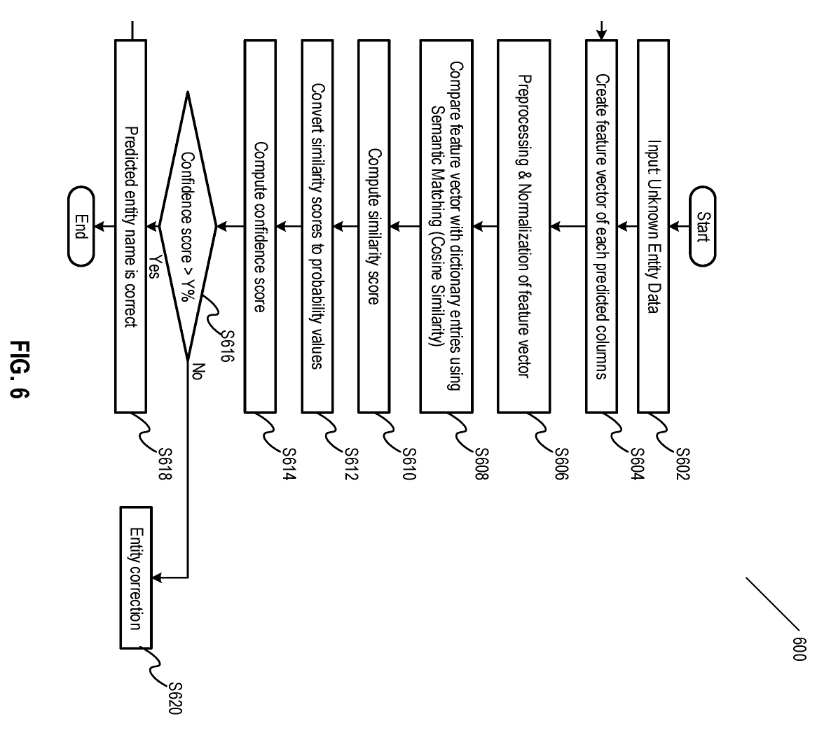

FIG. 6 illustrates an example process flow 600 for performing entity prediction and validation, in accordance with an example implementation. The system first performs entity prediction and verifies the correctness of predicted entity names in tabular datasets by using semantic similarity and confidence scoring. The process begins at step S602 where unknown entity data (dataset containing columns with unknown entity names) is input. At step S604, feature vector extraction is performed to extract feature vectors/representations that correspond to the predicted entities. Specifically, a feature vector is created for each predicted column using the trained model. These vectors are encoded with semantic and contextual information to ensure robust entity representations.

At step S606, preprocessing and normalization of the feature vector are performed. Specifically, scaling and transformation techniques are applied to standardize the extracted feature vectors. This ensures that the feature vectors are comparable across different entities.

The process then continues to step S608 where the feature vector is compared against entity entries as contained in the dynamic dictionary using semantic matching (cosine similarity). The predicted feature vector is compared against stored entity feature vectors in the dynamic dictionary, and cosine similarity is computed to measure the closeness of the predicted entity to existing entries.

At step S610, the system calculates similarity scores between the predicted entity’s feature vector and stored dictionary entries. This numerical similarity value indicates how closely the predicted entity matches known entities.

At step S612, the similarity scores are converted into probability values. Specifically, the computed similarity scores are normalized into probability values using a SoftMax function or other transformation techniques. This ensures that the predicted entity can be interpreted with confidence levels.

At step S614, a confidence score is computed from the probability values. The final confidence score is determined based on the probability distribution of similarity values. This confidence score serves as the basis for entity validation. At step S616, a determination is made to see whether the confidence score exceeds a confidence threshold (e.g., Y%). If the answer is yes at step S616, then the process continues to step S618 where it is determined that the entity prediction/predicted entity name is correct. The process then loops back to step S604 to perform entity recognition/prediction for the next entity column in the dataset. If the answer is no at step S616, then the process continues to step S620 where entity correction is performed.

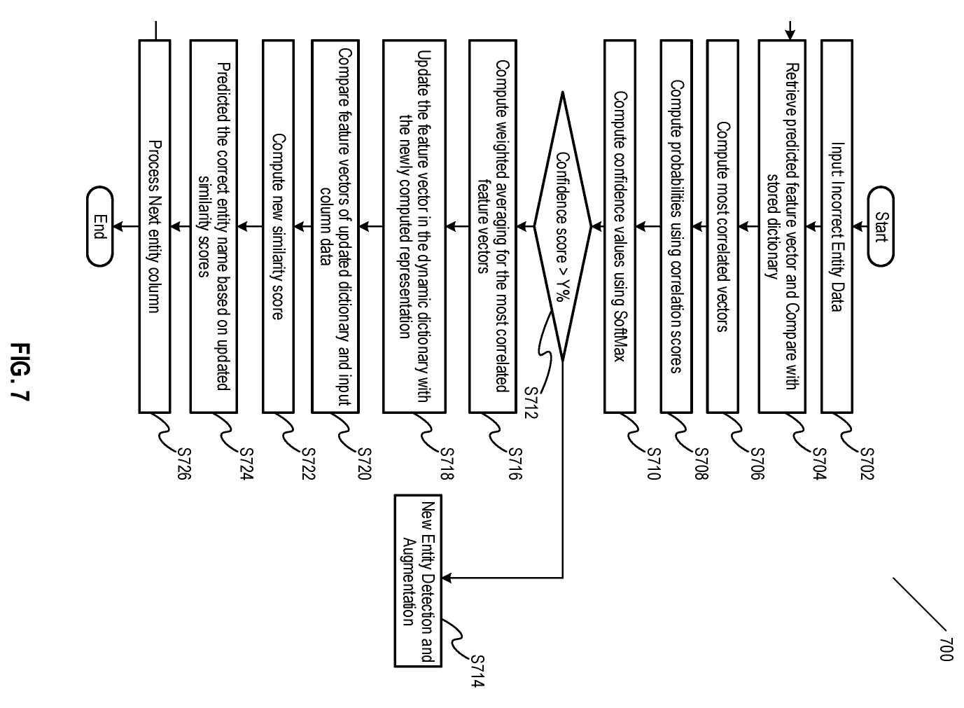

FIG. 7 illustrates an example process flow 700 for performing entity correction, in accordance with an example implementation. Process flow 700 refines misclassified entities in tabular datasets by leveraging correlation-based feature updates. The system ensures that incorrectly predicted entity names are corrected using feature vector relationships, reducing errors and improving prediction accuracy.

At step S702, a predicted entity that failed entity validation is taken as input for correction. Specifically, the feature vector of the predicted entity is retrieved from the dynamic dictionary. At step S704, the feature vector of the predicted entity is compared against other entries contained in the dynamic dictionary. The system fetches the feature vector of the incorrectly predicted entity and compares it with existing feature vectors stored in the dynamic dictionary to identify potential corrections.

To enhance entity correction, feature vectors from the dynamic dictionary having highest semantic similarity (most correlated feature vectors) with the feature vector of the predicted entity are identified at step S706. At step S708, probabilities are computed using correlation scores/coefficients between the predicted entity and the most correlated entities/entries. Specifically, correlation coefficients between the predicted entity and the most correlated stored entities are converted into probability values, reflecting the likelihood of each correction candidate being the correct entity.

At step S710, confidence values are computed from the probability values. Specifically, the confidence values are computed using a SoftMax function to normalize probability values and generate a confidence score for each correction candidate. The process then continues to step S712 where a determination is made to see whether one or more of the confidence values exceeds a confidence threshold/predetermined threshold (e.g., Y%).

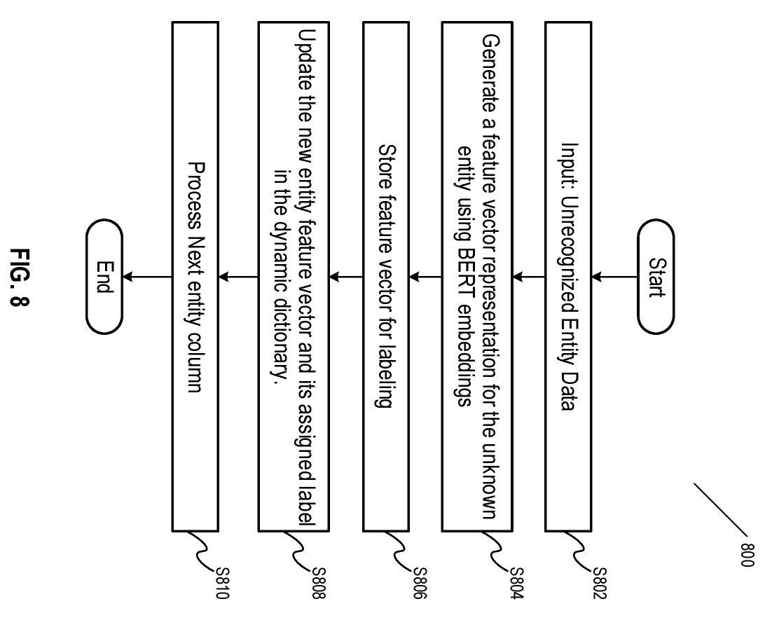

If the answer is no at step S712, then the process continues to step S714 where new entity detection and augmentation will be performed, which is described in more detail in relation to FIG. 8 below. If the answer is yes at step S716, computation of weighted averaging of the most correlated feature vectors is performed. Specifically, the system refines the incorrect entity’s feature vector by averaging it with the most correlated vectors, using correlation coefficients as weights, to derive a newly generated feature vector.

At step S718, the feature vector of the predicted entity/incorrect entity is replaced with the newly generated feature vector in the dynamic dictionary. At step S720, semantic similarity check is performed between the updated feature vector and the input column data. The process then continues to step S722 where a new similarity score is calculated using the updated feature vector. Calculation of the similarity score ensures that the correction is reliable.

At step S724, entity prediction based on updated similarity score is performed and entity assignment is made to assign the correct entity name based on entity prediction. At step S726, the next entity column is processed to ensure that the correction pipeline is applied to the next data column. The process is repeated by returning to step S702 to process any remaining misclassified entities.

FIG. 8 illustrates an example process flow 800 for performing new entity detection and augmentation, in accordance with an example implementation. Process flow 800 identifies, classifies, and integrates previously unrecognized entities into the dynamic dictionary. By leveraging BERT-based embeddings, the system ensures continuous learning and adaptability for entity recognition in structured datasets.

The process begins at step S802 where unrecognized entity data is input. Unrecognized entity data is data in which entity validation had failed and entity detection is needed. At step S804, a feature vector representation is generated for the unrecognized entity data. A pre-trained transformer model (e.g., Bidirectional Encoder Representations from Transformers (BERT) embeddings) is used to generate a dense vector representation of the unrecognized entity. This feature vector captures semantic and contextual relationships associated with the unknown entity.

At step S806, automated labelling process is performed on the feature vector to label the feature vector. In some example implementations, in additional to the automated process, a human annotator may also review the generated label to verify the entity's classification. Once the entity label is generated, the process then continues to step S808 where the dynamic dictionary is updated with a new entry that comprises the new entity and the associated feature vector for future recognition.

At step S810, the next entity column is processed to validate and classify any additional unknown entities, ensuring continuous learning and dynamic adaptability. The process flow 800 enables real-time adaptation to new entity types, ensuring that the dynamic dictionary evolves over time without requiring frequent model retraining.

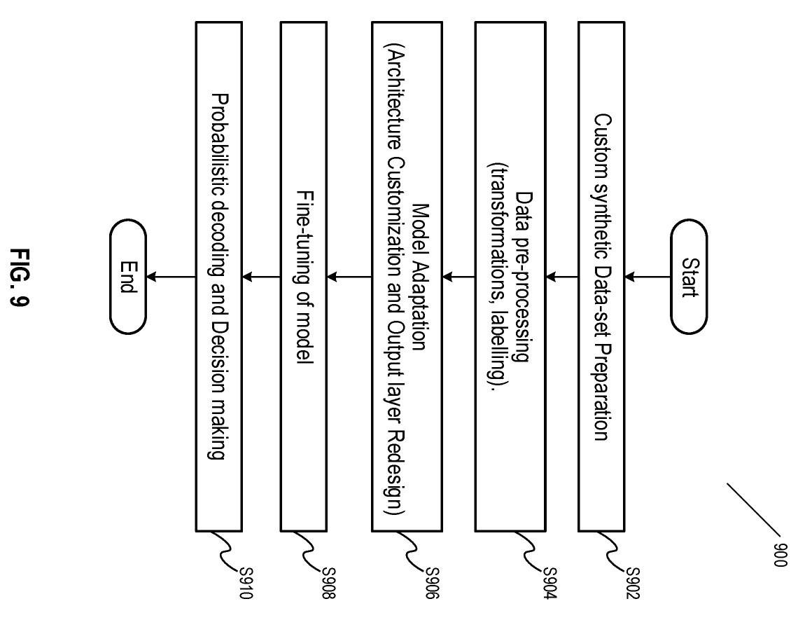

FIG. 9 illustrates an example process flow 900 for performing model adaptation and fine-tuning, in accordance with an example implementation. Specifically, model adaptation and fine-tuning are performed on data files (e.g., Comma-separated Values (CSV) files) to efficiently detect PII entities in such files. At step S902, custom synthetic dataset is prepared . The synthetic dataset (synthetic data 120) is generated and used as training dataset.

At step S904, data preprocessing is performed on the synthetic data. Preprocessing may include data cleaning, transformatng (converting columns into sequences), and labeling using temporary identifiers to standardize input formats. The process then continues to step S906 where model adaptation is performed using preprocessed synthetic data. Model adaptation customizes the model architecture, refines the output layer, and optimizes hyperparameters to align with PII entity recognition.

Once adapted, fine-tuning of the model is performed at step S908. Model fine-tuning may involve dataset splitting, model training, validation, and hyperparameter optimization to ensure robustness in entity classification. At step S910, probabilistic decoding and decision making are performed. Probabilistic decoding and decision-making are performed for PII column detection on the input data to identify column names based on the predictions.

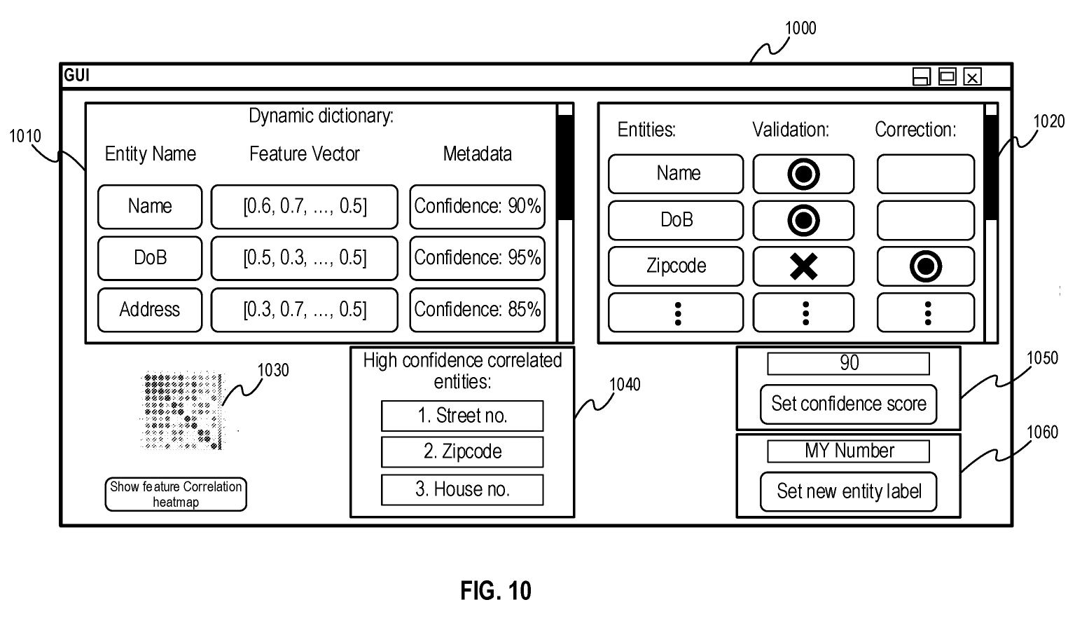

FIG. 10 illustrates an example Graphical User Interface (GUI) 1000, in accordance with an example implementation. The GUI 1000 is designed to facilitate dynamic entity validation, correction, and augmentation using the dynamic dictionary-based approach. A dynamic dictionary panel 1010 is used to display stored entity names, associated feature vectors, and metadata (e.g., confidence scores). The validation and correction panel 1020 allows real-time validation of predicted entities, where correctly identified entities are marked, and incorrect predictions are flagged for correction.

The GUI 1000 further includes a feature correlation heatmap 1030 that visually represents relationships between entities and assists users in understanding feature similarities. A high confidence correlated entities panel 1040 lists entities with strong semantic correlations, and provides recommendations for potential corrections. A confidence score adjustment module 1050 enables users to manually set the confidence threshold for validation to refine the entity recognition process. In some example implementations, the GUI 1000 may also include a new entity labeling module 1060 that allows users to assign labels to previously unidentified entities to update the dynamic dictionary for future reference.

The foregoing example implementation may have various benefits and advantages, such as a unique way of performing entity prediction, validation, correction, and augmentation in tabular datasets using a context-aware feature-based dynamic system. Unlike traditional entity recognition methods that rely on predefined rules or multiple embedding engines, example implementations dynamically learn from data, allowing accurate identification of entities even when column names are unknown. Utilization of the dynamic dictionary eliminates the need for frequent model retraining by continuously updating feature representations. Further, the dictionary enables efficient entity validation and correction, reduces dependency on static classification rules, and improves adaptability to changing datasets.

Predicted entity names can be validated using semantic matching and confidence scoring. Example implementations also apply feature vector correlations and weighted averaging to correct misclassified entities. Unknown entities may be detected using pretrained models (e.g., BERT) to update the dynamic dictionary for future adaptability. Example implementations minimize computational overhead, ensures adaptability to evolving datasets, and automates entity recognition in structured data.

For misclassified entities, a predicted entity correction method is applied, which refines entity classification through weighted averaging of feature vector correlations. The system identifies related feature vectors in the dynamic dictionary, applies correlation coefficients as weights, and updates the classification of the entity. This approach ensures that misclassified entities are corrected in an automated and data-driven manner without manual intervention.

If an entity is not found within the dynamic dictionary, an automatic unknown entity detection and augmentation method is triggered. The system extracts a feature vector for the unknown entity using a pretrained transformer model and assigns a provisional label through an automated process or human intervention. The new entity is then stored in the dynamic dictionary, ensuring future recognition and reducing the need for frequent model retraining.

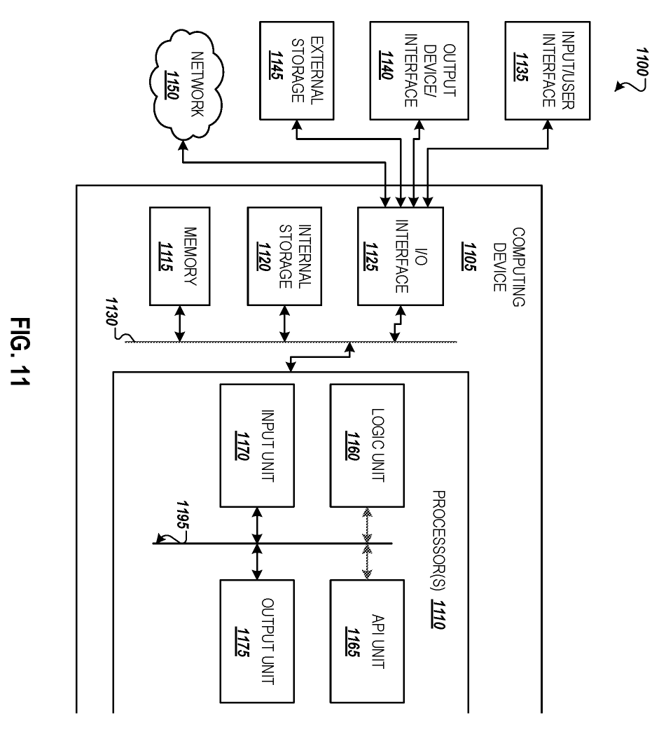

FIG. 11 illustrates an example computing environment with an example computer device suitable for use in some example implementations. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or IO interface 1125, any of which can be coupled on a communication mechanism or bus 1130 for communicating information or embedded in the computer device 1105. IO interface 1125 is also configured to receive images from cameras or provide images to projectors or displays, depending on the desired implementation.

Computer device 1105 can be communicatively coupled to input/user interface 1135 and output device/interface 1140. Either one or both of the input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via IO interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

IO interface 1125 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, the input unit 1170, the output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide an output based on the calculations described in example implementations.

Processor(s) 1110 can be configured to receive data to be classified as shown in FIGS. 2 and 6. The processor(s) 1110 may also be configured to generate an entity prediction and a feature vector from the data using a trained Artificial Intelligence (AI) model as shown in FIGS. 2 and 6. The processor(s) 1110 may also be configured to compute a confidence score for the entity prediction from the feature vector as shown in FIGS. 2 and 6. The processor(s) 1110 may also be configured to compare the confidence score against a confidence threshold as shown in FIGS. 2 and 6. The processor(s) 1110 may also be configured to for the confidence score being equal to or less than the confidence threshold, perform entry update on a dynamic dictionary stored in the data storage, wherein the dynamic dictionary comprises a plurality of entity entries with extracted feature vectors as shown in FIGS. 2 and 6.

The processor(s) 1110 may also be configured to receive synthetic data for performing entity recognition as shown in FIG. 1. The processor(s) 1110 may also be configured to perform training of an AI model using the synthetic data to generate the trained AI model as shown in FIG. 1.

The processor(s) 1110 may also be configured to receive the plurality of entity entries as output from the trained AI model with the synthetic data as input as shown in FIGS. 1 and 4. The processor(s) 1110 may also be configured to perform feature vector extraction for the plurality of entity entries to generate the extracted feature vectors as shown in FIGS. 1 and 4. The processor(s) 1110 may also be configured to store the plurality of entity entries and the extracted feature vectors as entries in the dynamic dictionary for validation as shown in FIGS. 1 and 4.

The processor(s) 1110 may also be configured to compare the feature vector against the extracted feature vectors to compute similarity scores between the feature vector and the extracted feature vectors as shown in FIG. 2 and 6. The processor(s) 1110 may also be configured to convert the similarity scores into the confidence score as shown in FIG. 2 and 6.

The processor(s) 1110 may also be configured to identify a subset of the extracted feature vectors with closest semantic similarity to the feature vector from the extracted feature vectors as shown in FIGS. 3 and 7. The processor(s) 1110 may also be configured to compute one or more correlation coefficients between the feature vector and the subset of the extracted feature vectors as shown in FIGS. 3 and 7. The processor(s) 1110 may also be configured to convert the one or more correlation coefficients into one or more probability values as shown in FIGS. 3 and 7. The processor(s) 1110 may also be configured to compare the one or more probability values against a second confidence threshold as shown in FIGS. 3 and 7.

The processor(s) 1110 may also be configured to, for all of the one or more probability values being less than or equal to the second confidence threshold, generate a new entry for the data in the dynamic dictionary as shown in FIGS. 3 and 7-8.

The processor(s) 1110 may also be configured to, for at least one probability value of the one or more probability values being determined to exceed the second confidence threshold, determine entity correction is required for entity entry associated with the entity prediction as contained in the dynamic dictionary as shown in FIGS. 3 and 7. The processor(s) 1110 may also be configured to generate a weighted averaged feature vector by performing weighted averaging of (i) the feature vector; and (ii) at least one feature vector associated with the at least one probability value as shown in FIGS. 3 and 7. The processor(s) 1110 may also be configured to correct the entity entry associated with the entity prediction by replacing the feature vector with the weighted averaged feature vector in the dynamic dictionary as shown in FIGS. 3 and 7.

The processor(s) 1110 may also be configured to, for the confidence score being greater than the confidence threshold, output the entity prediction and the feature vector for review as shown in FIG. 10. The processor(s) 1110 may also be configured to display the entity prediction, the feature vector, and the confidence score using a graphical user interface as shown in FIG. 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform the desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for performing entity detection, the method comprising:
receiving, by a processor, data to be classified;
generating, by the processor, an entity prediction and a feature vector from the data using a trained Artificial Intelligence (AI) model;
computing, by the processor, a confidence score for the entity prediction from the feature vector;
comparing, by the processor, the confidence score against a confidence threshold; and
for the confidence score being equal to or less than the confidence threshold, performing, by the processor, entry update on a dynamic dictionary, wherein the dynamic dictionary comprises a plurality of entity entries with extracted feature vectors.

2. The method of claim 1, wherein the trained AI model is generated by:
receiving synthetic data for performing entity recognition; and
performing training of an AI model using the synthetic data to generate the trained AI model, wherein the trained AI model performs entity recognition and prediction on input data.

3. The method of claim 2, wherein the dynamic dictionary is generated by:
receiving the plurality of entity entries as output from the trained AI model with the synthetic data as input;
performing feature vector extraction for the plurality of entity entries to generate the extracted feature vectors; and
storing the plurality of entity entries and the extracted feature vectors as entries in the dynamic dictionary for validation.

4. The method of claim 1, wherein the processor is configured to compute the confidence score for the entity prediction by:
comparing the feature vector against the extracted feature vectors to compute similarity scores between the feature vector and the extracted feature vectors; and
converting the similarity scores into the confidence score.

5. The method of claim 1, wherein the processor is configured to perform the entry update on the dynamic dictionary by:
identifying a subset of the extracted feature vectors with closest semantic similarity to the feature vector from the extracted feature vectors;
computing one or more correlation coefficients between the feature vector and the subset of the extracted feature vectors;
converting the one or more correlation coefficients into one or more probability values; and
comparing the one or more probability values against a second confidence threshold.

6. The method of claim 5, wherein the processor is configured to perform the entry update on the dynamic dictionary by further performing:
for all of the one or more probability values being less than or equal to the second confidence threshold:
generating a new entry for the data in the dynamic dictionary, wherein the new entry comprises an entity label and a newly generated feature vector of the data derived using a pre-trained transformer model.

7. The method of claim 6, wherein the pre-trained transformer model comprises a Bidirectional Encoder Representations from Transformers (BERT) model.

8. The method of claim 5, further comprising:
for at least one probability value of the one or more probability values being determined to exceed the second confidence threshold:
determining entity correction is required for entity entry associated with the entity prediction as contained in the dynamic dictionary;
generating a weighted averaged feature vector by performing weighted averaging of (i) the feature vector; and (ii) at least one feature vector associated with the at least one probability value; and
correcting the entity entry associated with the entity prediction by replacing the feature vector with the weighted averaged feature vector in the dynamic dictionary.

9. The method of claim 1, further comprising:
for the confidence score being greater than the confidence threshold, outputting, by the processor, the entity prediction and the feature vector for review.

10. The method of claim 9, further comprising:
displaying, by the processor, the entity prediction, the feature vector, and the confidence score using a graphical user interface.

11. A system for performing entity detection, the system comprising:
a data storage; and
a processor in communication with the data storage, wherein the processor is configured to:
receive data to be classified;
generate an entity prediction and a feature vector from the data using a trained Artificial Intelligence (AI) model;
compute a confidence score for the entity prediction from the feature vector;
compare the confidence score against a confidence threshold; and
for the confidence score being equal to or less than the confidence threshold, perform entry update on a dynamic dictionary stored in the data storage, wherein the dynamic dictionary comprises a plurality of entity entries with extracted feature vectors.

12. The system of claim 11, wherein the trained AI model is generated by:
receiving synthetic data for performing entity recognition; and
performing training of an AI model using the synthetic data to generate the trained AI model, wherein the trained AI model performs entity recognition and prediction on input data.

13. The system of claim 12, wherein the dynamic dictionary is generated by:
receiving the plurality of entity entries as output from the trained AI model with the synthetic data as input;
performing feature vector extraction for the plurality of entity entries to generate the extracted feature vectors; and
storing the plurality of entity entries and the extracted feature vectors as entries in the dynamic dictionary for validation.

14. The system of claim 11, wherein the processor is configured to compute the confidence score for the entity prediction by:
comparing the feature vector against the extracted feature vectors to compute similarity scores between the feature vector and the extracted feature vectors; and
converting the similarity scores into the confidence score.

15. The system of claim 11, wherein the processor is configured to perform the entry update on the dynamic dictionary by:
identifying a subset of the extracted feature vectors with closest semantic similarity to the feature vector from the extracted feature vectors;
computing one or more correlation coefficients between the feature vector and the subset of the extracted feature vectors;
converting the one or more correlation coefficients into one or more probability values; and
comparing the one or more probability values against a second confidence threshold.

16. The system of claim 15, wherein the processor is configured to perform the entry update on the dynamic dictionary by further performing:
for all of the one or more probability values being less than or equal to the second confidence threshold:
generate a new entry for the data in the dynamic dictionary, wherein the new entry comprises an entity label and a newly generated feature vector of the data derived using a pre-trained transformer model.

17. The system of claim 16, wherein the pre-trained transformer model comprises a Bidirectional Encoder Representations from Transformers (BERT) model.

18. The system of claim 15, wherein the processor is further configured to:
for at least one probability value of the one or more probability values being determined to exceed the second confidence threshold:
determine entity correction is required for entity entry associated with the entity prediction as contained in the dynamic dictionary;
generate a weighted averaged feature vector by performing weighted averaging of (i) the feature vector; and (ii) at least one feature vector associated with the at least one probability value; and
correct the entity entry associated with the entity prediction by replacing the feature vector with the weighted averaged feature vector in the dynamic dictionary.

19. The system of claim 11, wherein the processor is further configured to:
for the confidence score being greater than the confidence threshold, output the entity prediction and the feature vector for review.

20. The system of claim 19, wherein the processor is further configured to:
display the entity prediction, the feature vector, and the confidence score using a graphical user interface.
